(19) United States
(12) Patent Application Publication
(10) Pub. No.: US 2015/0071258 A1
(43) Pub. Date: Mar. 12, 2015

(54) RANDOM ACCESS ALGORITHM FOR LTE SYSTEMS

(71) Applicants: Luca SANGUINETTI, Pisa (IT); Michele MORELLI, Fornacette (PI) (IT); Leonardo MARCHETTI, Lucca (IT)

(72) Inventors: Luca SANGUINETTI, Pisa (IT); Michele MORELLI, Fornacette (PI) (IT); Leonardo MARCHETTI, Lucca (IT)

(21) Appl. No.: 14/023,737

(22) Filed: Sep. 11, 2013

(51) Int. Cl. H04W 74/08; H04W 56/00

(52) U.S. Cl. CPC H04W 74/0833; H04W 56/00
USPC 370/336

(57) ABSTRACT

A method for initial synchronisation in a random access procedure in LTE standards provides dividing the Physical Random Access Channel (PRACH) into a plurality of tiles, each comprising by a adjacent subcarriers, over which the channel response is assumed to be substantially flat, i.e. the frequency response is replaced over each subcarrier of a tile with an average frequency response. In an embodiment, an algorithm for initial synchronization is provided on the basis of a generalized likelihood ratio test (GLRT).

### FIELD OF THE INVENTION

The present invention relates to a RA method that is specifically tailored for LTE applications.

The main features of the method are fully described in L. Sanguinetti, M. Morelli and L. Marchetti, “A random access algorithm for LTE systems”, TRANSACTIONS ON EMERGING TELECOMMUNICATIONS TECHNOLOGIES, Trans. Emerging Tel. Tech. (2012), which is incorporated here as a reference.

In particular, the present invention relates to an algorithm for initial synchronization in LTE systems.

### BACKGROUND OF THE INVENTION

Long-term evolution (LTE) has been introduced by the Third-Generation Partnership Project (3GPP) in order to face the ever-increasing demand for packet-based mobile broadband communications. This emerging technology employs orthogonal frequency-division multiple-access (OFDMA) for downlink transmission and single-carrier frequency-division multiple-access (SC-FDMA) in the uplink [1]. To maintain orthogonality among subcarriers of different users, the 3GPP-LTE specifies a network entry procedure called random access (RA) by which uplink signals can arrive at the eNodeB aligned in time and with approximately the same power level [2], [3].

In its basic form, the RA function is a contention-based procedure, which essentially develops through the same steps specified by the Initial Ranging (IR) process of the IEEE 802.16 wireless metropolitan area network [4].

Specifically, each user equipment (UE) trying to enter the network computes frequency and timing estimates on the basis of a suitably designed downlink control channel. The estimated parameters are next used in the subsequent uplink step, during which the UE selects a time-slot and transmits a randomly chosen code over the Physical Random Access Channel (PRACH), which is composed by a specified set of adjacent subcarriers. The codes are usually obtained by applying different cyclic shifts to a Zadoff-Chu (ZC) sequence, in order to ensure their mutual orthogonality [5].

As a consequence of the different terminals' positions within the cell, uplink signals are subject to users' specific propagation delays and arrive at the eNodeB at different time instants. After identifying which codes are actually present in the PRACH (active codes), the eNodeB must extract the corresponding timing and power information. Then, it will broadcast a response message indicating the detected codes and giving instructions for timing and power adjustment.

From the above discussion, it follows that code identification as well as multiuser timing and power estimation are the main tasks of the eNodeB during the RA process. These problems have received great attention in the last few years and some solutions are currently available [6]-[15].

The methods illustrated in [6] and [7] perform code detection and timing recovery by correlating the received samples with time-shifted versions of a training sequence. The code is detected if the correlation peak exceeds a specified threshold, with the peak position providing the timing information. Since these schemes operate in the time-domain, they are not suited for multicarrier systems, wherein users' codes are transmitted over a subset of the available subcarriers. In such a case, the frequency-domain correlation approach outperforms its time-domain counterpart as it can easily extract the PRACH from data-bearing subcarriers [8].

A simple energy detector is employed in [9] to reveal the presence of a network entry request. However, since this approach requires that the user's codes are real-valued, it cannot be applied to the ZC sequences employed in the LTE.

A timing recovery scheme devised for the LTE uplink is discussed in [10]. Here, the PRACH is firstly extracted from the uplink multiuser signal by means of a discrete Fourier transform (DFT) operation. Then, the corresponding frequency-domain samples are multiplied by the root ZC sequence and converted into the time-domain by means of an inverse DFT (IDFT) device. The code detection process searches for the peak of the resulting timing metric within an observation window that is univocally specified by the cyclic shift associated to the tested code. If the peak exceeds a suitably designed threshold, the code is declared to be active and the corresponding timing estimate is obtained as the difference between the peak location and the beginning of the observation window. This method is expected to work properly as long as the received codes maintain their orthogonality after passing through the propagation channel.

However, in the presence of multipath distortions, the PRACH subcarriers may experience different attenuations and phase shifts, thereby leading to a loss of code orthogonality. This gives rise to multiple-access interference (MAI), which may severely degrade the code detection capability.

Possible approaches to mitigate the MAI are proposed in [11]-[15].

More precisely, in [11] the users' codes are divided into several groups which are mapped over exclusive sets of subcarrier in order to make them perfectly separable in the frequency domain. In the signal design illustrated in [12], the codes are transmitted in the time direction over a specified number of OFDMA blocks. This way, the code orthogonality is maintained as long as the channel response keeps constant over the entire transmission slot. However, using a relatively large number of OFDMA blocks increases the sensitivity to residual carrier frequency offsets (CFOs), which may compromise the orthogonality of the received codes.

Ranging schemes that are robust to frequency errors are presented in [13] and [14], where users' CFOs are estimated by resorting to subspace-based methods. In [15], the generalized likelihood ratio test (GLRT) criterion is applied to decide whether a given code is present or not in the ranging subchannel. The proposed scheme is fully compliant with the IEEE 802.16 specifications and inherently takes into account the multipath distortions introduced by the propagation channel.

In spite of their resilience to MAI, the schemes discussed in [11]-[15] are based on signal designs that cannot be supported by the PRACH structure and, accordingly, they are not suited for LTE systems.

### SUMMARY OF THE INVENTION

It is therefore an object of the present invention to provide a method for initial synchronisation between an eNodeB station and a user equipment in a random access procedure in Long-Term Evolution standards that is able to take into account the presence of multipath distortions, in order to prevent or to limit the loss of code orthogonality and, therefore, multiple-access interference.

It is also an object of the present invention to provide such a method that can be implemented at a reduced computational load.

It is also an object of the present invention to provide such a method that produces an unbiased estimate of the power level by which the uplink signals reach the eNodeB station.

These and other objects are achieved by a method for initial synchronisation between an eNodeB station (eNB) and a user equipment (UE) in a random access (RA) procedure in Long-Term Evolution (LTE) standards in wireless communication systems,

comprising the steps of:
defining a Physical Random Access Channel (PRACH), the PRACH comprising a set of adjacent subcarriers;
notifying an entry request by a UE, the step of notifying comprising transmitting a random access RA code over the PRACH, the RA code randomly selected from a prefixed set of codes;
extracting the PRACH at the eNB, the step of extracting producing extracted samples;
processing the extracted samples, comprising the steps of:
   detecting the random access code;
   calculating a timing estimate;
   calculating a power estimate,
for the initial synchronization
   wherein
a step is provided of arranging the PRACH into tiles, each tile of said tiles comprising a predetermined subset (M) of adjacent subcarriers of the PRACH, and
the step of processing the extracted samples is carried out for each of the tiles.

In formulating the testing problem, the PRACH is divided into sub-bands referred to as “tiles”, each composed by a certain number of adjacent subcarriers over which the channel is assumed to be constant. Compared to the prior art techniques, such as [10], where the channel is assumed to be constant throughout all the subcarriers of the PRACH, the present invention provides a method with improved resilience against multipath distortions.

Therefore, in contrast to the prior art techniques, the present invention provides better results by properly taking into account the frequency selectivity of the channel.

In particular, in the step of processing the extracted samples, a uniform channel response is assumed over each of the tiles, i.e. for each of the subcarriers of each of the tile, equal to an average frequency response.

Advantageously, the step of detecting the random access code comprises a binary hypothesis test wherein, for each code of the codes of the set of codes, a hypothesis of existence of the code is compared with a hypothesis of non-existence of the code.

In particular, the binary hypothesis test is a GLRT test. In the GLRT test, a step may be provided of calculating a timing estimate, along with a step of calculating an estimate of the channel response in the hypothesis of existence of the code, and a step of calculating a noise estimate may also be provided for both the hypothesis of existence and of non existence of the codes.

Preferably, the step of calculating a timing estimate and the step of calculating an estimate of the channel response timing error and the channel frequency response of the hypothesized codes are jointly carried out by using a maximum-likelihood (ML) criterion. In other words, the timing error and the channel frequency response of the hypothesized codes are assumed to be unknown and are jointly estimated using the maximum-likelihood (ML) criterion. The power level of the detected codes is eventually retrieved from the estimated channel frequency response. Therefore, the invention provides a novel RA method which is specifically tailored for LTE applications and makes use of the GLRT to decide whether a given code is present or not in the PRACH.

More in particular, if the hypothesis of existence of a code of the codes is validated, the step of calculating a power estimate is carried out for the same code. On the contrary, if the hypothesis of non-existence of a code of the codes is validated, the step of processing the extracted samples continues by the binary hypothesis test for another of the codes.

Advantageously, the step of calculating a power estimate comprises the steps of calculating a noise variance estimate and combining the and the noise variance and the power estimate to provide an unbiased estimate of the power. This leads to a more optimize the accurate estimate of the power.

In an embodiment, the step of processing the extracted samples comprises, for each of the tiles, a step of applying an inverse discrete Fourier transform (IDFT). This provides a low computational load way to carry out the processing, i.e. of detecting the random access code and to calculate estimates of the timing and of the power.

In the step of calculating a timing estimate, the number of subcarriers (M) of each of the tiles may be selected responsive to the number of subcarrier (M_{θ}) leading to a minimum value of the variance of timing estimate. In particular, the number of subcarriers (M_{P}) of each of the tiles is set between 3 and 10, in particular is set between 4 and 7.

In the step of calculating a power estimate, the number of subcarriers (M_{θ}) of each of the tiles is selected responsive to the number of subcarrier leading to a minimum value of the variance of power estimate. In particular, the number of subcarriers (M_{P}) of each of the tiles is higher than 10, in particular is higher than 25.

Advantageously, the number of subcarriers (M) of each of the tiles is selected as an unique value both in the step of calculating a timing estimate and in the step of calculating a power estimate as a trade-off value. In particular, the number of subcarriers (M) is set between 10 and 15, in particular is set between 11 and 14.

As alternative to simultaneously, i.e. jointly determinating the RA code, the timing estimate and the power estimate, the step of processing the extracted sample may comprise individually determinating the above parameters by a specific optimality criterion.

Advantageously, the steps of calculating a timing estimate and of calculating a noise estimate are carried out by a
detecting the random access code;
calculating a timing estimate, and
calculating a power estimate of the step of processing the extracted samples are carried out jointly.

As alternative to simultaneously, i.e. jointly determinating the RA code, the timing estimate and the power estimate, the step of processing the extracted samples may comprise individually determinating the above parameters by a specific optimality criterion.

### BRIEF DESCRIPTION OF THE DRAWINGS

The invention will be now shown with the following description of an exemplary embodiment thereof, exemplifying but not limitative, with reference to the attached drawings in which:

FIG. 1 is a block diagram of the method according to the invention, in which the PRACH is divided into a plurality of tiles;

FIG. 2 is a block diagram of the method according to the invention in which the step of processing the extracted samples is carried out by a GLRT criterion;

FIG. 3 is a block diagram of an embodiment of the method according to the invention in which the step of processing the extracted samples is carried out by a GLRT criterion and the power estimate is calculated by an unbiased estimator;

FIG. 4 is a block diagram of an embodiment of the method in which the step of extracted samples processing is carried out by a reduced computational load procedure;

FIG. 5 is a block diagram of an embodiment of the method providing the procedure of FIG. 4 for a multiple-antennas receiver;

FIG. 6 is a plot of the variance of the timing estimate nvar(\hat{θ}₁) vs. the number M_{θ} of tiles into which the PRACH is arranged for different signal-to noise ratio values (SNR) at the eNB and with K=1 and R=1;

FIG. 7 is a plot of the variance of the timing estimate vs. SNR with K=1 and R=1, and for a conventional random access (CRA) and a random access scheme based on generalized likelihood test;

FIG. 8 is a plot of the normalized variance of the power estimate nvar[\hat{p}₁^{(f)}] vs. the number Mₚ of tiles into which the PRACH is arranged for different SNR values and with K=1 and R=1;

FIG. 9 is a plot of the of the normalized variance of the power estimate vs. SNR with K=1 and R=1, and for a conventional random access (CRA) and a random access scheme based on generalized likelihood test;

FIG. 10 is a plot of the variance of the timing estimate vs. SNR with K=1 and R=1, 2, 4, for a random access scheme based on generalized likelihood test;

FIG. 11 is a plot of the variance of the normalized variance of the power estimate vs. SNR with K=1 and R=1, 2, 4, for a random access scheme based on generalized likelihood test;

FIG. 12 is a plot of the variance of the timing estimate vs. the number of user equipment (K) for a random access scheme based on generalized likelihood test, when SNR is 12 and dB and R=1 or 4;

FIG. 13 is a plot of the variance of the normalized variance of the power estimate vs. the number of user equipment (K) for a random access scheme based on generalized likelihood test, when SNR is 12 dB and R=1 or 4.

### DESCRIPTION OF PREFERRED EXEMPLARY EMBODIMENTS

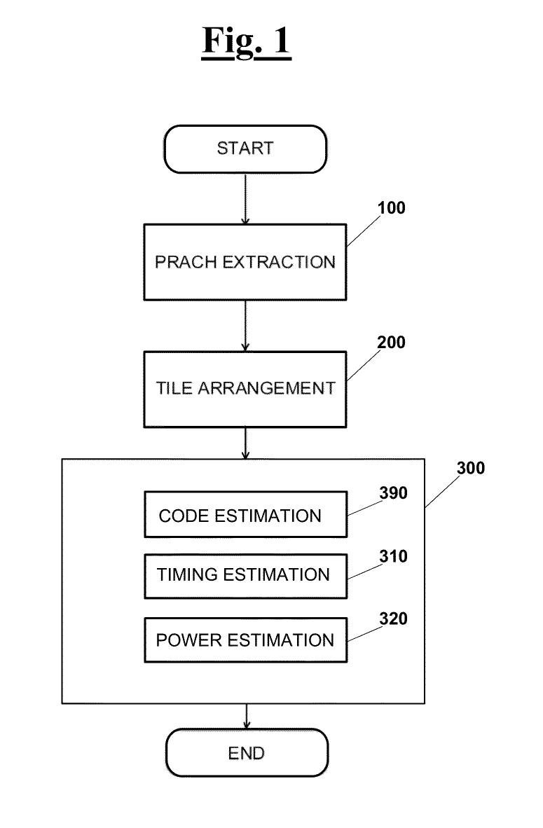

With reference to FIG. 1 a method is described, according to the invention, for initial synchronisation between an eNodeB station (eNB) and a user equipment (UE) in a random access (RA) procedure in Long-Term Evolution (LTE) standards in wireless communication systems. The procedure according to the invention is carried out by the eNB at regular intervals, while constantly monitoring the signals coming from the cell, in which one or more user equipments may be notifying an entry request by a UE, by transmitting a random access code over a Physical Random Access Channel (PRACH). As know from the above standards, the RA code is randomly selected from a prefixed set of codes.

The method comprises a step 100 of extracting the PRACH at the eNB, i.e a step in which data are collected from the cell in the form of complex samples.

According to the invention a step 200 is provided of arranging, i.e, dividing, the PRACH into tiles, each tile of the tiles comprising a predetermined subset (M) of adjacent subcarriers of the PRACH.

The subsequent step 300 of processing the extracted samples is carried out for each tile, and comprises essentially a step 390 of detecting the random access code used by any UE possibly active within the cell, as well as steps 310 and 320 of computing estimates of UE operating parameters. These estimate will be used in the initial synchronization between the UE and the eNB, according to the cited standards, and comprise a step 310 of timing estimate, i.e. a step 310 of a communication delay estimate, and a step 320 of computing the estimate of the power by which the UE is received at the eNB.

Typically, the step 200 of arranging the PRACH into tiles provides a uniform channel response over each tile, i.e. for each of the subcarriers of each tile, which is equal to an average frequency response.

### System Description and Signal Model

The method according to the present invention is compliant with the LTE-3GPP standard for wireless data communications. Let B be the available bandwidth and let K be the number of UEs that are simultaneously trying to enter the network. As previously mentioned, each UE notifies its entry request by transmitting a randomly chosen code over the PRACH.

According to the standard, a set C of 64 different RA codes are available in each cell. These codes are generated by cyclically shifting one or more ZC root sequences of prime-length N_{ZC}=839. Specifically, denoting by

ξᵤ(n)=e^{jπun(n+1)}/N_{ZC} n=0, 1, . . . , N_{ZC}−1 {1},

the elements of the u^{th} ZC root sequence, the ν^{th} RA code obtained from ξᵤ(n) has entries

x_{u,ξ}(n)=ξᵤ((n+C_{ξ}) mod N_{ZC}) {2}

where C_{ξ} denotes the ξ^{th} cyclic shift. The latter is given by C_{ξ}=ξN_{CS}, where N_{CS} is a system parameter related to the cell radius (the larger the radius, the greater N_{CS}) and ξ is an integer belonging to the set {0, 1, 2, . . . , N_{U}−1}, with N_{U}=[N_{ZC}/N_{CS}] and └x┘ rounding x to the smallest integer. Bearing in mind that 64 different codes must be available in C and observing that a total of N_{U} codes are generated from a single ZC root sequence, it follows that two or more root sequences are necessary whenever N_{U}<64. In the present description, let be N_{CS}=13, which amounts to assuming a cell radius of approximately 1.5 km. The description can be easily extended to different values of N_{CS}. In these circumstances, N_{U}=64 and, accordingly, one single root sequence is sufficient for the generation of the 64 codes in C. Therefore, the index u can be omitted in the following description. Also, without loss of generality, different UEs select different codes with indices {1, 2, . . . ,K}.

As specified in [2], the PRACH occupies a bandwidth B_{RA}=1.08 MHz. This value corresponds to the smallest uplink bandwidth of six resource blocks in which LTE may operate. The subcarrier spacing is Δf_{RA}=1.25 kHz. Vector xₖ=[xₖ{0}, xₖ{1}, . . . , xₖ(N_{ZC}−1)]^{T} is transmitted over the PRACH subcarriers using an OFDM modulator, which comprises an IDFT unit of size N=B/Δf_{RA} along with the insertion of a cyclic prefix and a guard time of N_{CP} and N_{GT} samples, respectively. This produces the N_{CP}=N+N_{CP}+N_{GT} time-domain samples given by

$$\begin{matrix}{s}_{k} ( l ) = \{ \begin{matrix}{b}_{k} ( l ) & 0 \leq l \leq N + {N}_{CP} - 1 \\ 0 & N + {N}_{CP} \leq l \leq {N}_{B} - 1\end{matrix} \\ where & \{ 3 \} \\ {b}_{k} ( l ) = \frac{1}{\sqrt{N}} {\sum }_{n = 0}^{{N}_{ZC} - 1} {x}_{k} ( n ) {e}^{j2π {i}_{n} l / N} & \{ 4 \}\end{matrix}$$

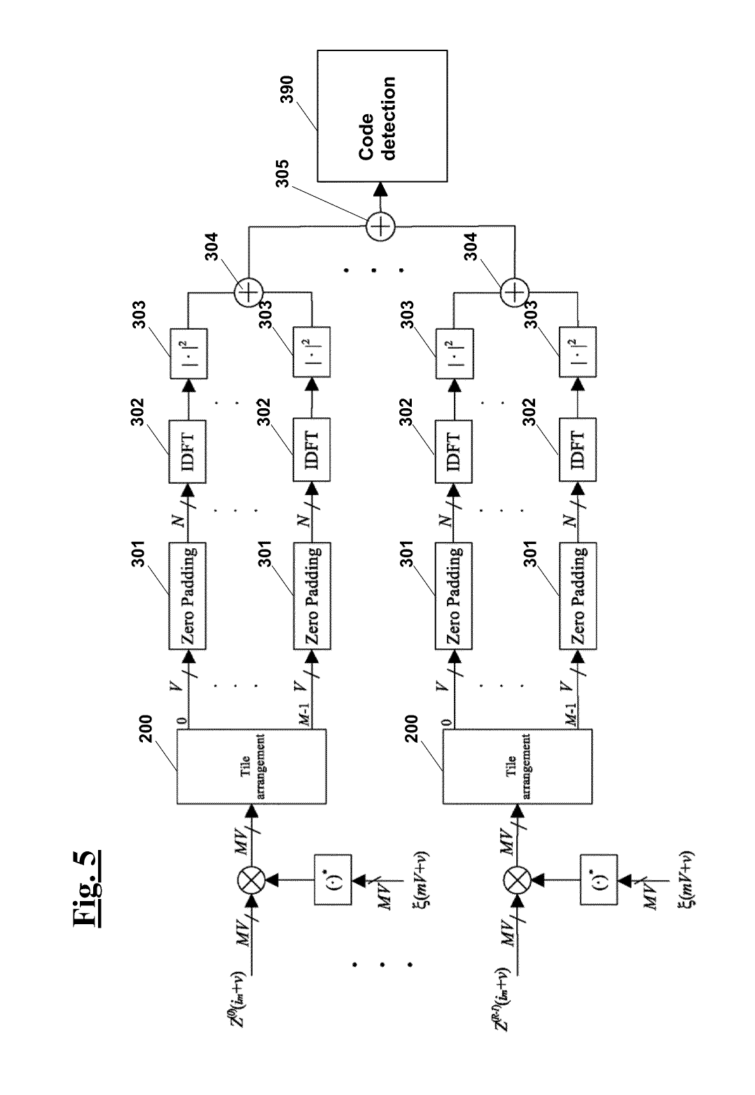

with iₙ being the frequency index of the n^{th} PRACH subcarrier. Samples sₖ(1) are eventually fed to a digital-to-analog converter (DAC) with impulse response g(t) and signaling interval T=1/B or, equivalently, T=1/(NΔf_{RA}). The complex envelop of the signal transmitted by the k^{th} UE takes the form

$${z}_{k} ( t ) = {\sum }_{l = 0}^{{N}_{B} - 1} {s}_{k} ( l ) g ( t - lT ) \qquad \{ 5 \}$$

where g(t) is the DAC impulse response. This signal propagates through a multipath channel and arrives at the eNodeB. The eNB may be equipped with a plurality R of antennas, to improve the step 300 of processing the extracted samples is carried, as shown, in n embodiment of the method, in FIG. 5.

, which, in this case, is assumed to be equipped with R antennas. At each antenna, the received signal is down-converted to baseband and sampled at a rate 1/T. The resulting time domain samples are next passed to an N-point DFT unit to extract the PRACH. Due to the different positions occupied by the users within the cell, the uplink signals are received at the eNodeB with specific timing offsets. Let θₖ be the timing error of the k^{th} UE expressed in sampling intervals. As mentioned previously, each UE performs its uplink transmission by using the frequency estimates obtained during the downlink step. Accordingly, the received signals are also affected by the CFOs induced by downlink estimation errors and/or Doppler effects. The presence of uncompensated CFOs destroys orthogonality among PRACH subcarriers and gives rise to interchannel interference. In the following, it is assumed that downlink estimation errors are within a few percents of the subcarrier spacing and consider low mobility applications characterized by negligible Doppler shifts so as to reasonably neglect any residual CFO. Moreover, it is assumed that users other than those performing the RA have been successfully synchronized to the eNodeB so that they do not generate significant interference over the PRACH [10]. In these hypotheses, the DFT output over the ⁱₙth subcarrier at the r^{th} antenna of R antennas can be approximated as follows:

$${Z}^{( r )} ( {i}_{n} ) = {\sum }_{k = 1}^{K} {x}_{k} ( n ) {H}_{k}^{( r )} ( {i}_{n} ) {e}^{- j2π {i}_{n} {θ}_{k} / N} + {w}^{( r )} ( {i}_{n} ) \qquad \{ 6 \}$$

where Hₖ^{(r)}(iₙ) is the k^{th} channel frequency response over the iₙ^{th} subcarrier at the r^{th} antenna, while w^{(r)}(iₙ) accounts for background noise and is modeled as a circularly-symmetric complex Gaussian random variable with zero mean and variance σ_{w}².

### Problem Formulation

The eNodeB exploits the quantities {Z^{(r)}(iₙ)} to detect the active codes and for extracting the associated timing and power information. Since it has no knowledge as to which codes are actually present in the PRACH, the summation in {6} must be extended over the entire code set C, with the assumption that Hₖ^{(r)}(iₙ)=0 if the k^{th} code is not active. Then,

$${Z}^{( r )} ( {i}_{n} ) = {\sum }_{k ∈ 𝒞} {x}_{k} ( n ) {H}_{k}^{( r )} ( {i}_{n} ) {e}^{- j2π {i}_{n} {θ}_{k} / N} + {w}^{( r )} ( {i}_{n} ) \qquad \{ 7 \}$$

As previously mentioned, the RA subcarriers are divided into M tiles, each composed by

$$V = ⌊ \frac{{N}_{ZC}}{M} ⌋$$

adjacent subcarriers. The index of the ν^{th} subcarrier within the m^{th} tile will be denoted by iₘ+ν. Moreover, it is assumed that the channel response is nearly flat over a tile and the quantities

{Hₖ^{(r)}(i_{m+ξ})}_{ξ=0}^{V-1}

are replaced with an average frequency response given by

$${S}_{k}^{( r )} ( m ) = \frac{{e}^{- {j2πi}_{m} {θ}_{k} / N}}{V} {\sum }_{v = 0}^{V - 1} {H}_{k}^{( r )} ( {i}_{m} + v ) \qquad \{ 8 \}$$

In such a case, {7} may be rewritten as:

$${Z}^{( r )} ( {i}_{m} + v ) = {\sum }_{k ∈ C} {x}_{k} ( m V + v ) {S}_{k}^{( r )} ( m ) {e}^{- j2π v {θ}_{k} / N} ++ {w}^{( r )} ( {i}_{m} + v ) \qquad \{ 9 \}$$

while the power that the eNodeB receives from the k^{th} UE is found to be

$${p}_{k} = \frac{1}{MR} {\sum }_{r = 0}^{R - 1} {\sum }_{m = 0}^{M - 1} {\vert {S}_{k}^{( r )} ( m ) \vert}^{2} \qquad \{ 10 \}$$

To proceed further, the DFT outputs corresponding to the m^{th} tile are collected into a single vector

Z^{(r)}(m)=[Z^{(r)}(iₘ), Z^{(r)}(iₘ+1), . . . , Z^{(r)}(iₘ+V−1)]^{T}

### Then,

$${Z}^{( r )} ( m ) = {\sum }_{k ∈ 𝒞} {X}_{k} ( m ) a ( {θ}_{k} ) {S}_{k}^{( r )} ( m ) + {w}^{( r )} ( m ) \qquad \{ 11 \}$$

where w^{⇑}((r))(m)=[w^{⇑}((r))(i_{⇓}m), w^{⇑}(r))(i_{⇓}m+1), . . . , w^{⇑}((r)(i_{⇓}m+V−1]^{⇑}T is the noise vector, Hₖ(m) is a V×V diagonal matrix with elements {xₖ(mV+ξ)}_{ξ=0}^{V-1} main diagonal and a(θₖ) is expressed by

a(θₖ)=[1,e^{-j2πθ}^{ₖ}^{/N}, . . . , e^{-j2π(V-1)θ}^{ₖ}^{/N}]^{T} {12}

Code detection is now accomplished by resorting to a single-user strategy that operates individually for any xₖ ∈ C. More precisely, for each l=1, 2, . . . , |C|, where |·| denotes the cardinality of the enclosed set.

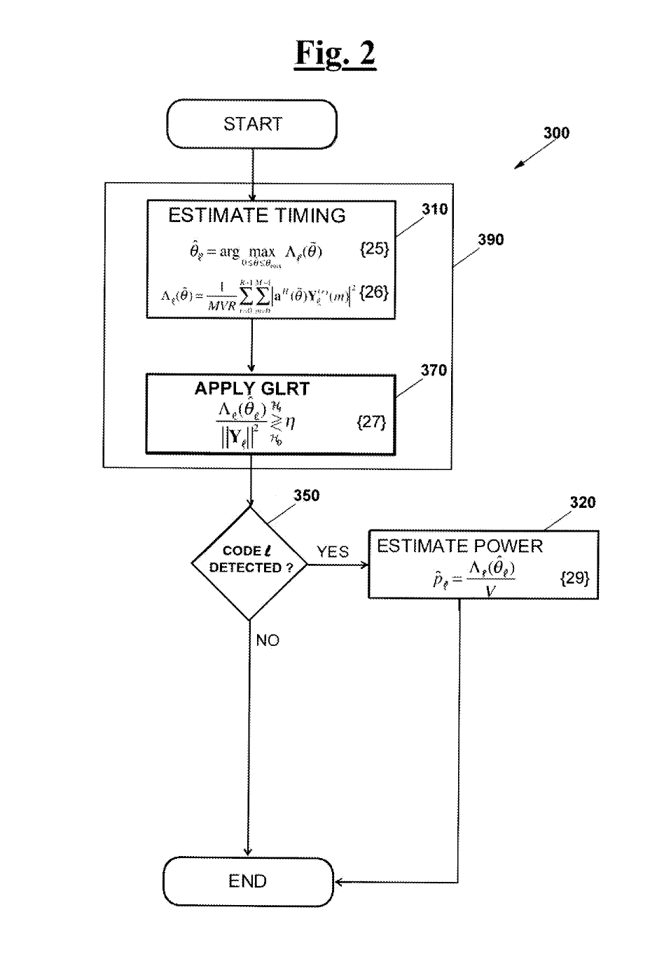

With reference to FIG. 2, in an embodiment, the step 390 of detecting the random access code comprises a binary hypothesis test wherein, for each code of the codes of the set of codes, a hypothesis H₁ of existence of the code is compared with a hypothesis H₀ of non-existence of the code. More in detail, the binary hypothesis test may be a GLRT test 370, in which the step 310 of calculating a timing estimate may require a step of calculating an estimate of the channel response in the hypothesis of existence H₁ of the code, and a step of calculating a noise estimate for both the hypothesis of existence H₁ and of non existence H₀ of the codes. The step 310 of calculating a timing estimate and the step of calculating an estimate of the channel response timing error and the channel frequency response of the hypothesized codes are jointly carried out by using a maximum-likelihood (ML) criterion.

More in detail, the eNodeB decides in favour of one of the following two hypotheses:
H₀) the code x₁ is not present in the observation vector

Z=[Z⁽⁰⁾^{^{T}}, Z⁽¹⁾^{^{T}}, . . . , Z^{(R-1)}^{^{T}}]^{T}, with

Z^{(r)}=[Z^{(r)}^{^{T}}(0),Z^{(r)}^{^{T}}(1), . . . , Z^{(r)}^{^{T}}(M−1)]^{T};
H₁) xₗ is present in Z.
   In doing so, the contribution of the active codes xₖ with indices k≠l is treated as a disturbance term which inevitably degrades the system performance. Although suboptimal, this approach has the advantage of allowing a simple formulation of the detection problem as a composite binary hypothesis test:

H₀: Yₗ^{(r)}(m)=nₗ^{(r)}(m) {13}

H₁: Yₗ^{(r)}(m)=a(θₗ)Sₗ^{(r)}+nₗ^{(r)}(m) {14}

where nₗ^{(r)}(m) accounts for the contribution of multiple-access interference, or MAI, plus thermal noise, while Yₗ^{(r)}(m) is defined as:

Yₗ^{(r)}(m)=Xₗ^{H}(m)Z^{(r)}(m). {15}

In all subsequent derivations, the entries of nₗ^{(r)}(m) are modeled as statistically independent Gaussian random variables with zero mean and unknown power σ².

Vector

Yₗ=[Yₗ⁽⁰⁾^{^{T}}, Yₗ⁽¹⁾^{^{T}}, . . . , Yₗ^{(R-1)}^{^{T}}]^{T},

with

Yₗ^{(r)}=[Yₗ^{(r)}^{^{T}}(0),Yₗ^{(r)}^{^{T}}(1), . . . , Yₗ^{(r)}^{^{T}}(M−1)]^{T}

is eventually exploited to make a decision between the two hypotheses H₀ and H₁. From {13} and {14}, it is seen that this task is complicated by the presence of the unknown parameters (Sₗ, θₗ, σ²), where

Sₗ=[Sₗ⁽⁰⁾^{^{T}},Sₗ⁽¹⁾^{^{T}}, . . . , Sₗ^{(R-1)}^{^{T}}]^{T}

and

[Sₗ^{(r)}(0),Sₗ^{(r)}(1), . . . , Sₗ^{(r)}(M−1)]^{T}

To overcome this problem, the GLRT criterion is applied hereinafter.

### 4. RA Algorithm Based on the GLRT Criterion

Let pdf_{H}_{₁} be the probability density function (pdf) of Yₗ under the hypothesis Hᵢ for i=0,1. Then, from {13} and {14},

$$\begin{matrix} {pdf}_{{ℋ}_{0}} ( {Y}_{𝓁} : {σ}^{2} ) = \frac{1}{{( {πσ}^{2} )}^{MVR}} {e}^{- \frac{1}{{σ}^{2}} {\sum }_{r = 0}^{R - 1} {\sum }_{m = 0}^{M - 1} {‖ {Y}_{𝓁}^{( r )} ( m ) ‖}^{2}} \\ and & \{ 16 \} \\ {pdf}_{{ℋ}_{1}} ( {Y}_{𝓁} : {S}_{𝓁} , {θ}_{𝓁} , {σ}^{2} ) = \frac{1}{{( {πσ}^{2} )}^{MVR}} \times {e}^{- \frac{1}{{σ}^{2}} {\sum }_{r = 0}^{R - 1} {\sum }_{m = 0}^{M - 1} {‖ {Y}_{𝓁}^{( r )} ( m ) - a ( {θ}_{𝓁} ) {S}_{𝓁}^{( r )} ( m ) ‖}^{2}} . & \{ 17 \}\end{matrix}$$

The GLRT is mathematically formulated as

$$\frac{{pdf}_{{ℋ}_{1}} ( {Y}_{𝓁} : {\hat{S}}_{𝓁} , {\hat{θ}}_{𝓁} , {\hat{σ}}_{{ℋ}_{1}}^{2} )}{{pdf}_{{ℋ}_{0}} ( {Y}_{𝓁} : {\hat{σ}}_{{ℋ}_{0}}^{2} )} {≷}_{{ℋ}_{0}}^{{ℋ}_{1}} λ \qquad \{ 18 \}$$

where λ is a suitable threshold, (Ŝₗ, \hat{θ}ₗ) is the ML estimate of (Sₗ,θₗ) and \hat{σ}_{H}_{ᵢ}² is the ML estimate of σ² conditioned on Hᵢ for i=0, 1.

### Code Detection and Timing Estimation

Maximizing pdf_{H}_{₀}(Yₗ;σ²) with respect to σ² produces

$${\hat{σ}}_{{ℋ}_{0}}^{2} = \frac{{‖ {Y}_{𝓁} ‖}^{2}}{MVR} \qquad \{ 19 \}$$

from which it follows that

$${pdf}_{{ℋ}_{0}} ( {Y}_{𝓁} : {\hat{σ}}_{{ℋ}_{0}}^{2} ) = {( \frac{MVR}{π e {‖ {Y}_{𝓁} ‖}^{2}} )}^{MVR} . \qquad \{ 20 \}$$

The maximum of pdf_{H}_{₁}(Yₗ;Sₗ,θₗ,σ²) is now searched in Equation {17} with respect to θ₁, while keeping σ² and S₁ fixed. This yields

$${\hat{θ}}_{𝓁} = arg {max}_{0 \leq \tilde{θ} \leq {θ}_{max}} {Λ}_{𝓁} ( \tilde{θ} ) \qquad \{ 21 \}$$

where θₘₐₓ is the maximum round trip delay while Λₗ(\tilde{θ}) takes the form

$${Λ}_{𝓁} ( \tilde{θ} ) = \frac{1}{MVR} {\sum }_{r = 0}^{R - 1} {\sum }_{m = 0}^{M - 1} {\vert {a}^{H} ( \tilde{θ} ) {Y}_{𝓁}^{( r )} ( m ) \vert}^{2} . \qquad \{ 22 \}$$

Maximizing pdf_{H}_{₁}(Yₗ;Sₗ,\hat{θ}ₗ,σ²) with respect to Sₗ leads to

$${\hat{S}}_{𝓁}^{( r )} ( m ) = \frac{1}{V} {a}^{H} ( {\hat{θ}}_{𝓁} ) {Y}_{𝓁}^{( r )} ( m ) \qquad \{ 23 \}$$

with m=0, 1, . . . , M−1. Substituting this result back into pdf_{H}_{₁}(Yₗ;Sₗ,\hat{θ}ₗ,σ²) with respect to σ² produces

$${\hat{σ}}_{{ℋ}_{1}}^{2} = \frac{1}{MVR} [ {‖ {Y}_{𝓁} ‖}^{2} MR {Λ}_{𝓁} ( {\hat{θ}}_{𝓁} ) ] \qquad \{ 24 \}$$

from which:

$${\hat{σ}}_{{ℋ}_{1}}^{2} = \frac{1}{MVR} [ {‖ {Y}_{𝓁} ‖}^{2} MR {Λ}_{𝓁} ( {\hat{θ}}_{𝓁} ) ] \qquad \{ 25 \}$$

From the above results, the GLRT is eventually found to be

$${[ \frac{{‖ {Y}_{𝓁} ‖}^{2}}{{‖ {Y}_{𝓁} ‖}^{2} - MR {Λ}_{𝓁} ( {\hat{θ}}_{𝓁} )} ]}^{MVR} {≷}_{{ℋ}_{0}}^{{ℋ}_{1}} λ \qquad \{ 26 \}$$

or, equivalently,

$$\frac{{Λ}_{𝓁} ( {\hat{θ}}_{𝓁} )}{{‖ {Y}_{𝓁} ‖}^{2}} {≷}_{{ℋ}_{0}}^{{ℋ}_{1}} η \qquad \{ 27 \}$$

with

$$η = \frac{[ 1 - {λ}^{- \frac{1}{MVR}} ]}{MR}$$

As still shown in FIG. 2, if the hypothesis of existence H₁ of a code of the codes is validated, the step 320 of calculating a power estimate is carried out for the same code, otherwise, the step 300 of processing the extracted samples continues by the binary hypothesis test for another of the codes.

### Power Estimation

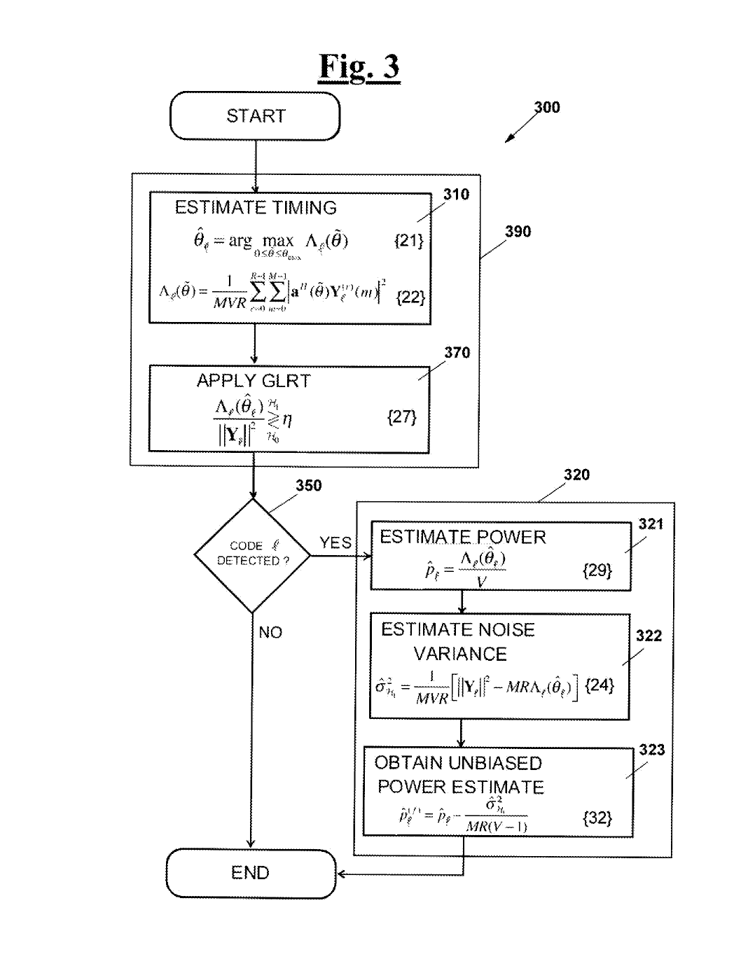

In a preferred embodiment, as shown in FIG. 3, the step 320 of calculating a power estimate comprises a steps 322 of calculating a noise variance estimate, and a step 323 of suitably combining 323 the noise variance and the power estimate to provide an unbiased estimate of the power, in order to improve the accuracy of th estimate of the power.

More in detail, using the invariance property of the ML estimator, from {10} it follows that the estimate of the power pₗ can be obtained as

$${\hat{p}}_{𝓁} = \frac{1}{MR} {\sum }_{r = 0}^{R - 1} {\sum }_{m = 0}^{M - 1} {\vert {\hat{S}}_{𝓁}^{( r )} ( m ) \vert}^{2} \qquad \{ 28 \}$$

or, equivalently,

$${\hat{p}}_{𝓁} = \frac{{Λ}_{𝓁} ( {\hat{θ}}_{𝓁} )}{V} \qquad \{ 29 \}$$

having used {22} and {23}. It is worth noting that, if the timing offset is perfectly estimated (i.e., \hat{θ}ₗ=θₗ), then

$$\begin{matrix}E \{ {\hat{p}}_{𝓁} \} = {p}_{𝓁} + \frac{{σ}^{2}}{MVR} \\ and & \{ 30 \} \\ E \{ {\hat{σ}}_{{ℋ}_{1}}^{2} \} = \frac{MR ( V - 1 )}{MVR} {σ}^{2} & \{ 31 \}\end{matrix}$$

from which it follows that \hat{p}₁ and \hat{σ}_{H}_{₁}² are biased estimates of pₗ and σ², respectively. From the above results, an unbiased estimate of pₗ is found to be

$${\hat{p}}_{𝓁}^{( f )} = {\hat{p}}_{𝓁} - \frac{{\hat{σ}}_{{H}_{1}}^{2}}{MR ( V - 1 )} \qquad \{ 32 \}$$

which can also be rewritten as

$${\hat{p}}_{𝓁}^{( f )} = \frac{1}{V - 1} [ {Λ}_{𝓁} ( {\hat{θ}}_{𝓁} ) - \frac{{‖ {Y}_{𝓁} ‖}^{2}}{MVR} ] . \qquad \{ 33 \}$$

Using standard computations, it turns out that the variance of \hat{p}ₗ for \hat{θ}ₗ=θₗ is given by

$$var \{ {\hat{p}}_{𝓁} \} = \frac{2 {p}_{𝓁}}{MVR} {σ}^{2} + \frac{{σ}^{4}}{MVR ( V - 1 )} . \qquad \{ 34 \}$$

Numerical results shown later indicate that different values of (M,V) should be used to optimize the accuracy of the power and timing estimators. This results into a modified scheme in which M and V are respectively replaced by M_{θ} and

$${V}_{ϑ} = ⌊ \frac{{N}_{ZC}}{{M}_{ϑ}} ⌋$$

for the evaluation of the timing metric [symbol] ₗ(õ) for \tilde{θ}=0, 1, . . . , θₘₐₓ
After obtaining the timing estimate \hat{θ}ₗ, Λₗ(\hat{θ}ₗ) is recomputed from {22} after replacing M and V

$${V}_{P} = ⌊ \frac{{N}_{ZC}}{{M}_{P}} ⌋ nd ,$$

respectively. Finally, Λₗ(\hat{θ}ₗ) is used in {33} to get the power estimate.

Hereinafter, reference is made to the above procedure as the GLRT-based RA scheme (GLRT-RA).

### Implementation and Complexity Analysis

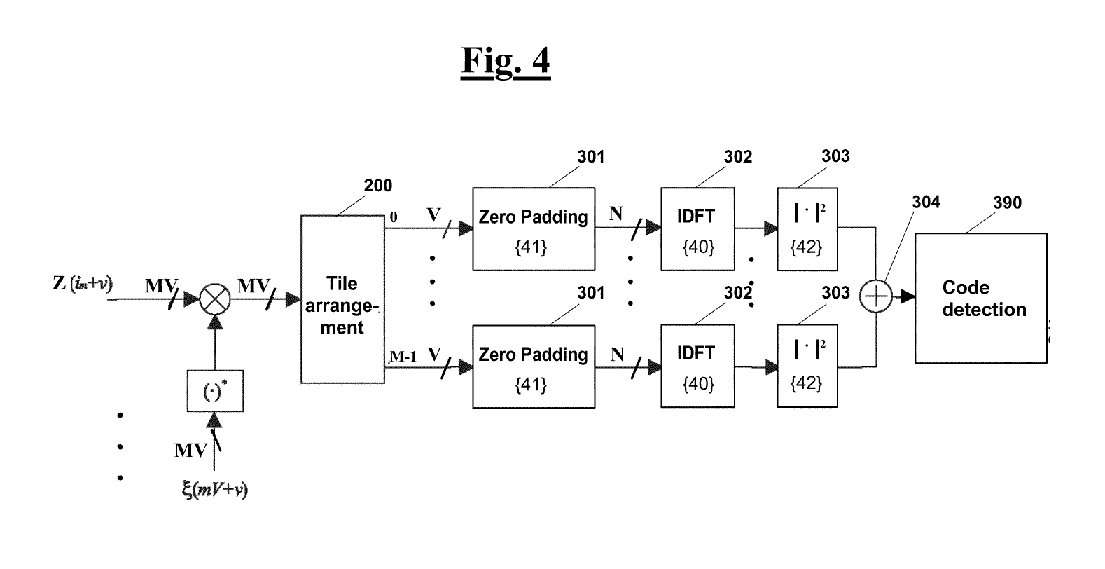

With reference to FIGS. 4 and 5, the step 300 of processing the extracted samples comprises, for each of the tiles, a step 302 of applying an inverse discrete Fourier transform (IDFT).

More in detail, the computational load of GLRT-RA is mainly involved in the evaluation of the timing metric [symbol] ₗ [symbol] (\tilde{θ}) for any possible code in the set C and for \tilde{θ}=0, 1, . . . , θₘₐₓ. In the following discussion, it is shown how the quantities [symbol] ₗ(\tilde{θ}) can be computed by exploiting the specific properties of the ZC sequences. At first, the right-hand side (RHS) of {22} is expanded. Taking into account {12} and {14},

$$\begin{matrix}{Λ}_{𝓁} ( \tilde{θ} ) = \frac{1}{MVR} {\sum }_{r = 0}^{R - 1} {\sum }_{m = 0}^{M - 1} {Λ}_{𝓁}^{( r )} ( m , \tilde{θ} ) \\ where & \{ 35 \} \\ {Λ}_{𝓁}^{( r )} ( m , \tilde{θ} ) = {\vert {\sum }_{v = 0}^{V - 1} {e}^{j 2 π v \tilde{θ} / N} {x}_{𝓁}^{*} ( mV + υ ) {Z}^{( r )} ( {i}_{m} + υ ) \vert}^{2} . & \{ 36 \}\end{matrix}$$

### Collecting {1} and {2},

xₖ(n)=ξ(n)e^{-j2πunC}^{ₖ}^{/N}^{_{ZC}}e^{-jφ}^{ₖ} {37}

from which it follows that the quantities {xₖ(n)} are obtained by superimposing a phase shift on the root sequence {ξ(n)}. Substituting {37} into {36} yields

$$\begin{matrix}{Λ}_{𝓁}^{( r )} ( m , \tilde{θ} ) = {\vert {\sum }_{v = 0}^{V - 1} {e}^{j \frac{2 π}{N} υ ( {uC}_{𝓁} \frac{N}{{N}_{ZC}} + \tilde{θ} )} {Z}_{ξ}^{( r )} ( mV + υ ) \vert}^{2} \\ where & \{ 38 \} \\ {Z}_{ξ}^{( r )} ( mV + υ ) = ξ ( mV + υ ) {Z}^{( r )} ( {i}_{m} + υ ) & \{ 39 \}\end{matrix}$$

### Denoting by

$${a}^{( r )} ( m , n ) = {\sum }_{n = 0}^{N - 1} {A}^{( r )} ( m , n ) {e}^{j 2 π nl / N} \qquad \{ 40 \}$$

the N-point IDFT of the sequence

$${A}^{( r )} ( m , n ) = \{ \begin{matrix}{Z}_{ξ}^{( r )} ( mV + n ) & 0 \leq n \leq V - 1 \\ 0 & V \leq n \leq N - 1\end{matrix} \qquad \{ 41 \}$$

The RHS of {38} may be rewritten as follows

Λₗ^{(r)}(m,\tilde{θ})=|a^{(r)}(m,└uCₗN/N_{ZC}+\tilde{θ}┘)|². {42}

From the above equation it is seen that, for any l ∈ C and \tilde{θ}=0, 1, . . . , θₘₐₓ, the quantities [symbol] ₗ^{(r)}(m,\tilde{θ}) are obtained from a single N-point IDFT operation applied to the sequence {A^{(r)}(m,n)}, thereby leading to the scheme depicted in FIG. 5.

The present description applies also to FIG. 4, which relates to the case of R=1 antenna at the eNodeB, by obvious modifications of the subscripts.

It is worth observing that the IDFT operation in FIG. 5 requires approximately 5ηNlog₂(N) floating-point operations (flops), with

$$η = 1 - \frac{{log}_{2} ( N / V ) + 2 ( V / N - 1 )}{{log}_{2} N} \qquad \{ 43 \}$$

accounting for the computational saving achievable by skipping the operations on the zero entries of {A^{(r)}(m,n)} [20]. Since the IDFT operation must be performed for any value of r and m, the total amount of flops required to evaluate the timing metrics [symbol] ₗ(\tilde{θ}) in {42} is 5MRηNlog₂(N). Recalling that different values of M and V are required for power and timing estimation, it follows that the overall number of flops needed by GLRT-RA is eventually given by 5(M_{θ}η_{θ}+Mₚηₚ)Nlog₂(N) where η_{θ} and ηₚ are obtained from {43} after replacing V with V_{θ} and Vₚ, respectively.

It is worth noting that a single IDFT operation is required when M_{θ}=Mₚ=1 and in such a case the scheme depicted in FIG. 5 reduces to the one illustrated in [10]. This means that GLRT-RA is equivalent to [10] under the assumption of a flat fading channel. Since in practical applications the received signal is typically affected by multipath distortions, the GLRT-RA is expected to provide some potential benefits with respect to [10]. As shown below, such an advantage is achieved at the price of a higher complexity since the required IDFT operations involved by GLRT-RA increases with the tile number.

### Numerical Results

### System Parameters

The system parameters are chosen in compliance with the LTE standard [2]. The signal bandwidth is B=7.68 MHz, so that the DFT size is N=B/Δf_{RA}=6144 and the sampling interval T is 130 ns. The cyclic prefix and guard time have duration of 0.1 ms, which corresponds to N_{CPT}+N_{GT}=768 samples. The carrier frequency is 2.6 GHz and the CFO of each UE is uniformly distributed in the interval (−0.01, 0.01). A root-raised cosine function is used with roll-off α=0.22 and duration T_{g}=6T as a modulation pulse. The path gains are modeled as statistically independent and circularly symmetric Gaussian random variables with zero mean and power delay profile as specified in the ITU IMT-2000 Vehic. A channel model [21]. A new channel snapshot is generated at each simulation run. The channel impulse responses of the active UEs have a maximum order of 30 and unit average power. Recalling that a cell radius of 1.5 km is considered, the maximum propagation delay, normalized by the sampling period T, θₘₐₓ is equal to 80.

The performance of GLRT-RA is first assessed in the presence of a single UE with a fixed timing offset θₗ=25, while the case of multiple UEs is considered later.

### Performance Evaluation

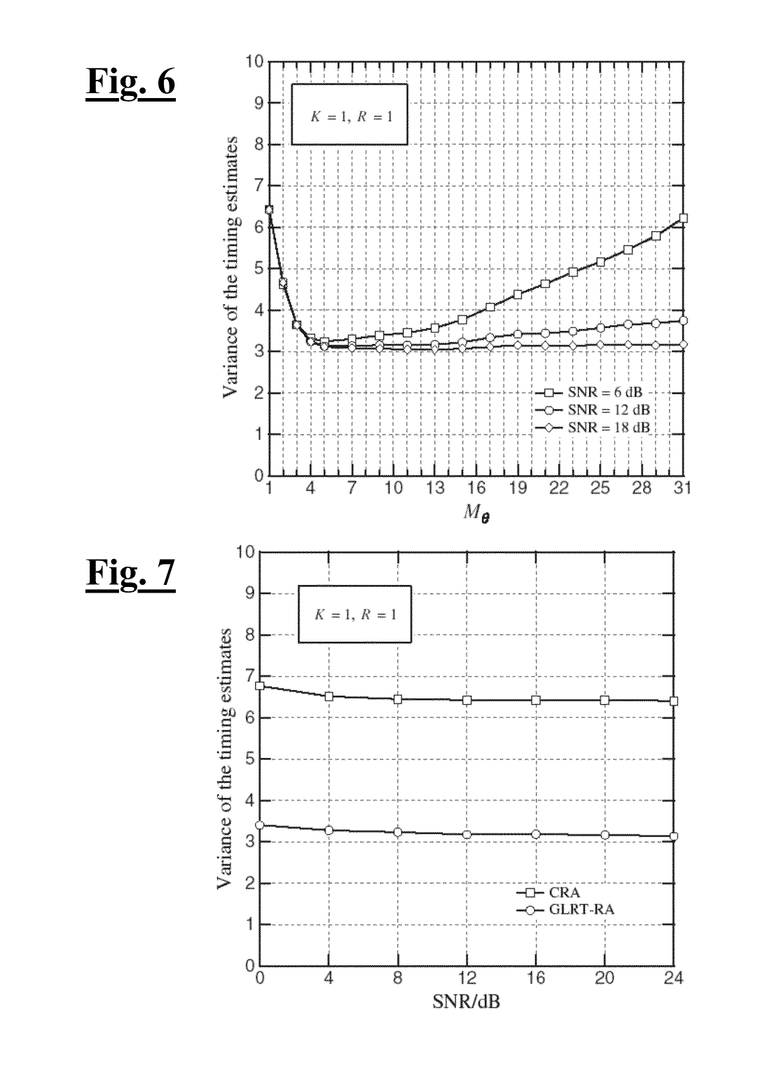

At first, the impact of the number of tiles on the timing estimation accuracy of GLRT-RA is evaluated. FIG. 6 illustrates the variance of the timing estimate \hat{θ}₁, defined as var(\hat{θ}₁)=E{(\hat{θ}₁−E{\hat{θ}₁})²}, vs. M_{θ} for different values of the SNR at the eNB and with K=1 and R=1. It is worth observing that, since θ₁ is the timing error normalized by the sampling period T, its estimate \hat{θ}₁ is an adimensional quantity.

FIG. 6 provides a suggestion for the selection of the number of subcarrier M_{θ} of each tile, in the step 310 of calculating a timing estimate, in the neighborhood of a number of tiles leading to a minimum value of the variance of timing estimate. As it is seen, the best results are obtained for 4≦M_{θ}≦7, while a degradation is observed for larger values of M_{θ} as the SNR decreases.

As expected, some advantage is achieved with respect to M_{θ}=1, which corresponds to the conventional RA scheme (CRA) illustrated in [10]. Since the number of flops required by GLRT-RA increases with M_{θ}, in all subsequent simulations M_{θ} is fixed to 4.

FIG. 7 illustrates var(\hat{θ}₁) as a function of the SNR with K=1 and R=1. Although the estimation accuracy of both CRA and GLRT-RA is only marginally affected by the SNR, a remarkable gain is achieved by using GLRT-RA in place of CRA.

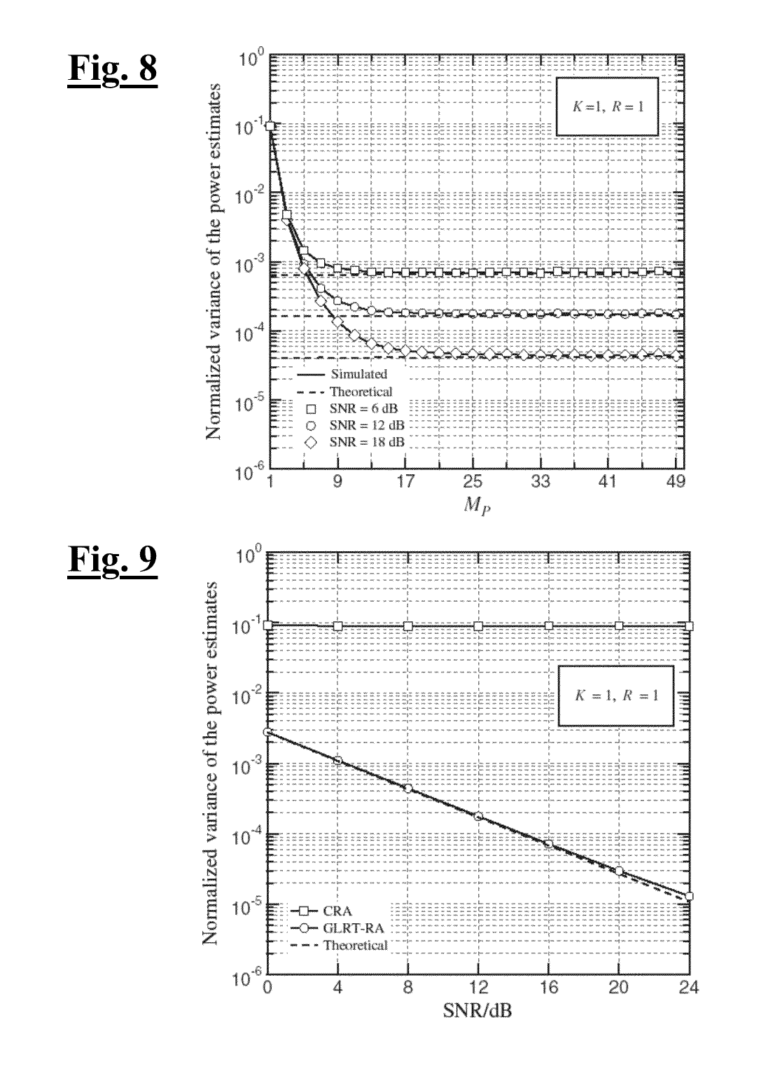

The performance of the power estimator is now assessed. For this purpose, FIG. 8 illustrates the normalized variance of the power estimate, say,

$$nvar ( {\hat{p}}_{1}^{( f )} ) = \frac{var \{ {\hat{p}}_{1}^{( f )} \}}{{[ E \{ {p}_{}^{1} \} ]}^{} 2}$$

as a function of Mₚ for different SNR values and with K=1 and R=1. The theoretical results given in {34} are also shown for comparison.

FIG. 8 provides a suggestion for the selection of the number of subcarrier Mₚ of each tile, in the step 320 of calculating a timing estimate, greater than a number of tiles leading to a minimum value of the variance of timing estimate. As is seen, the agreement between numerical results and theoretical analysis is achieved only when Mₚ is adequately large. In order to achieve a good trade-off between accuracy and system complexity, the value of Mₚ is chosen equal to 25.

The number of subcarriers of each tile may be selected as a trade-off value for both the step 310 of calculating a timing estimate and the step 320 of calculating a power estimate. In particular, M may be a value set between 10 and 15, more in particular set between 11 and 14.

In FIG. 9, nvar[\hat{p}ₗ^{(f)}] is shown as a function of the SNR with K=1 and R=1. As before, comparisons are made with the CRA scheme, which corresponds to setting Mₚ=1. From the above, GLRT-RA attains the theoretical results at all SNR values, while the accuracy of CRA is virtually independent of the SNR and exhibits a significant loss compared to GLRT-RA.

The code detection capability of the investigated schemes is assessed in terms of mis-detection probability P_{md} and false alarm probability P_{fa}. For this purpose, the SNR is set to 12 dB and K=R=1. Numerical results averaged over 50,000 channel realizations have shown that for threshold values centered around η=0.1 both GLRT-RA and CRA provide a P_{fa} smaller than 2·10⁻⁵. On the other hand, GLRT-RA achieves a P_{md} in the order of 7·10⁻⁴, while CRA provides P_{md}=4·4·10⁻². This means that GLRT-RA exhibits improved code detection capability with respect to CRA.

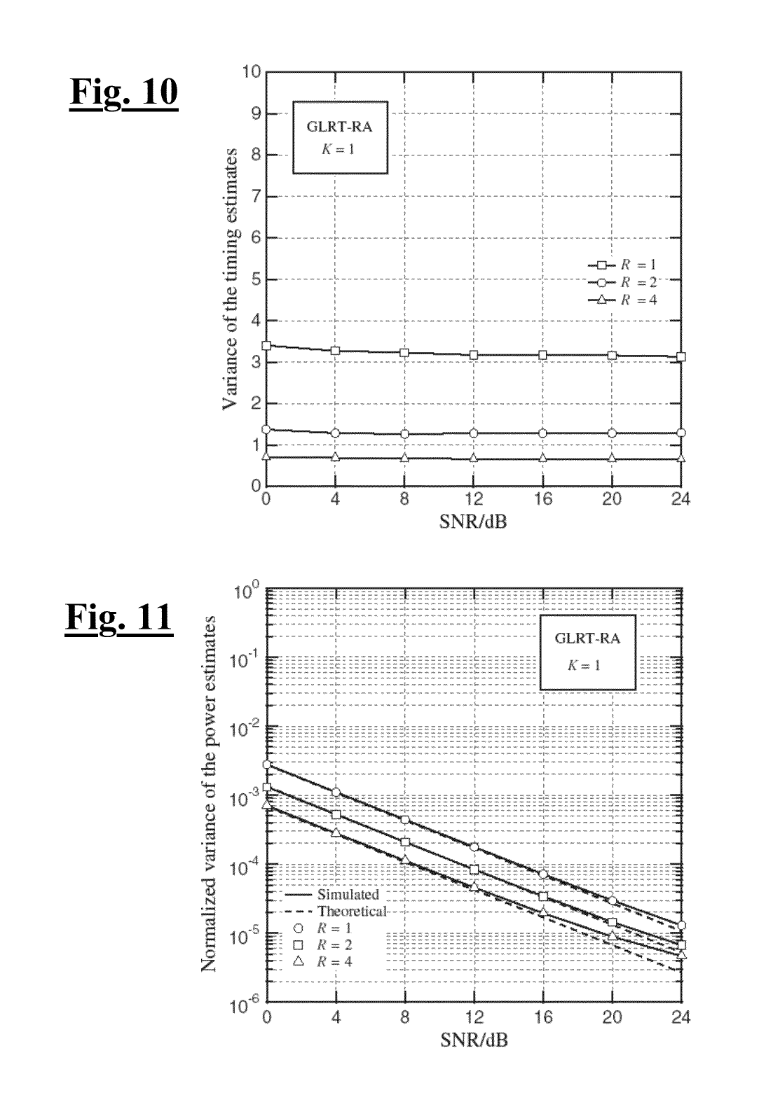

The performance of GLRT-RA when multiple antennas are employed at the eNodeB is now investigated. FIGS. 10 and 11 illustrate var(\hat{θ}₁) and nvar[\hat{p}₁^{(f)}] as a function of the SNR with K=1 and R=1, 2 or 4. As expected, increasing R improves the timing and power estimation accuracy of GLRT-RA. In particular, for SNR values smaller than 16 dB an array gain equal to 10 log(R) dB is achieved in terms of nvar[\hat{p}₁^{(f)}] with respect to a single-antenna scenario.

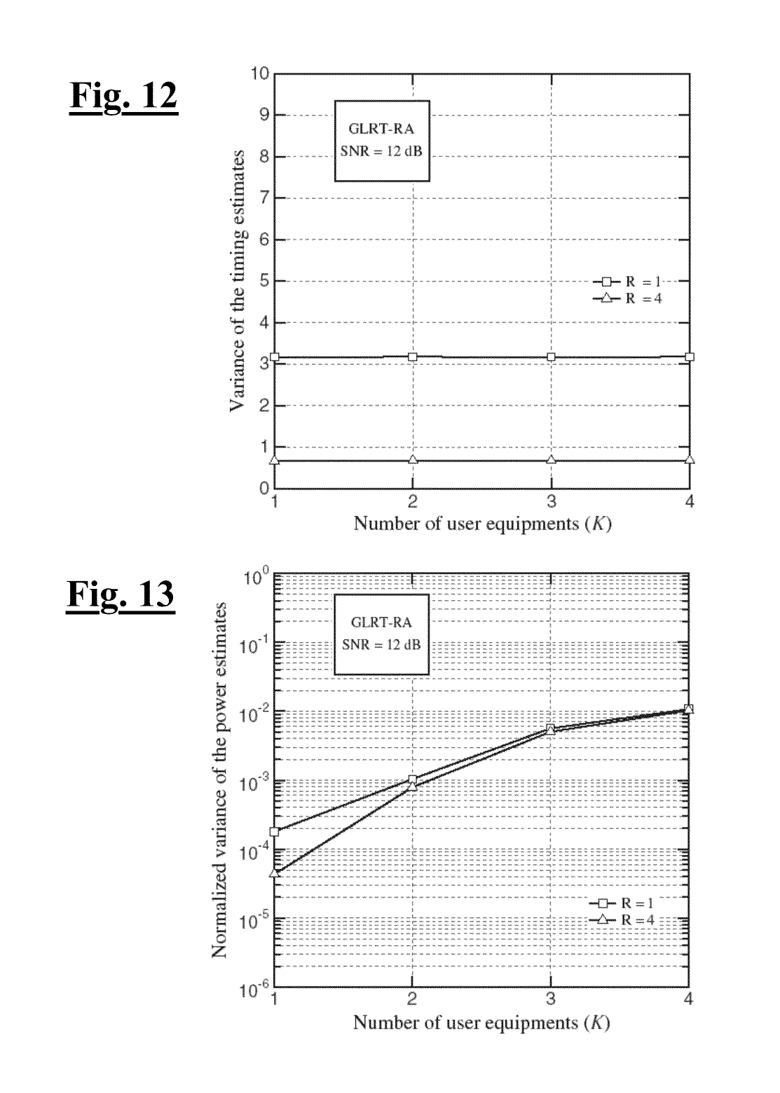

The performance of GLRT-RA in the presence of K UEs is reported in FIGS. 12 and 13 for R=1 or 4. Here, the timing offset of the k^{th} UE (with k=1, 2, . . . , K) is chosen equal to θ^{th}=25+5 (k−1), while the average signal power of all active UEs is set to unity. Without loss of generality, the system performance is measured on the basis of the signal received from the first UE. Inspection of FIG. 12 reveals that the accuracy of the timing estimates is virtually independent of the number of UEs, while the results in FIG. 13 indicate that the accuracy of the power estimator deteriorates as K grows from 1 to 4. Moreover, from FIG. 13 it follows that using more than one antenna has no practical benefit when K≧2.

### Computational Complexity

It is interesting to compare the investigated schemes in terms of their computational requirement. In doing so it is worth pointing out that, even though N=6144 is not a power of two, the number of flops involved in the IDFT operation in FIG. 5 is still well approximated by 5ηNlog₂(N) just because the IDFT size can be decomposed into the product of an integer number and a power of two as N=3·2¹¹. Hence, setting M_{θ}=4, V_{θ}=209, Mₚ=25, Vₚ=33 and R=1, the complexity of GLRT-RA is approximately 18.7 times higher than that involved by CRA. This means that the improved performance of GLRT-RA is achieved at the price of an increased computational load. However, the results shown in FIG. 6 indicate that, at practical SNR values around 10 dB, parameter Mₚ can be reduced from 25 to 11 with only a marginal loss of the estimation accuracy. The same value can be used for M_{θ} without incurring any significant degradation in the timing estimation accuracy for SNR≧12 dB. In these circumstances, one single IDFT operation can be used, thereby reducing the complexity of GLRT-RA by a factor 2.4. These arguments allow the system designer to achieve the desired trade-off between computational requirement and system performance.

In the foregoing description, a novel RA method which is specifically devised for low-mobility LTE-3GPP systems characterized by negligible Doppler shifts. The proposed scheme relies on the GLRT criterion to decide whether a given code is present or not in the PRACH and inherently takes into account the multipath distortions introduced by the propagation channel. After modeling the MAI as white Gaussian noise, the ML principle is employed to estimate the timing error and power level of the detected codes. Computer simulations indicate that the resulting scheme (GLRT-RA) outperforms the conventional RA method derived under the simplifying assumption of a flat-fading channel. The price for such a performance gain is a certain increase of the computational complexity. However, a judicious design of the algorithm parameters allows one to reduce the processing load without incurring any significant performance degradation.

The performance of the proposed invention has been evaluated by means of computer simulations. We evaluated the impact of the number of tiles on the timing and power estimation accuracy and the code detection capability of the investigated schemes is assessed in terms of mis-detection probability and false alarm probability. The system parameters and channel models have been chosen in compliance with the LTE standards.

The foregoing description of specific embodiments will so fully reveal the invention according to the conceptual point of view, so that others, by applying current knowledge, will be able to modify and/or adapt for various applications such embodiments without further research and without parting from the invention, and it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology employed herein is for the purpose of description and not of limitation.

### REFERENCES

[1] C. Ciochina, D. Mottier and H. Sari, “An analysis of three multiple access techniques for the uplink of future cellular mobile systems”, Eur. Trans. Telecomm., 19: 581-588, 2008.
[2] 3GPP TS 36.211 “Physical Channels and Modulation (Release 10)”.
[3] R. Müüllner, C. F. Ball, M. Boussif, J. Lienhart, P. Hric, H. Winkler, K. Kremnitzer and R. Kronlachner, “Enhancing uplink performance in UTRAN LTE networks by load adaptive power control”, Eur. Trans. Telecomm., 21: 458-468, 2010.
[4] “IEEE 802.16 2009—IEEE standard for local and metropolitan area network part 16: Air interface for broadband wireless access systems,” http://standards.ieee.org/getieee802/802.16.html, Tech. Rep., 2009.
[5] L. Li, P. Zhou, H. Hu and X. Zhang, “A robust cell search scheme for OFDMA systems”, Eur. Trans. Telecomm., 19: 935-940, 2008.
[6] X. Fu and H. Minn, “Initial uplink synchronization and power control (ranging process) for OFDMA systems,” in Proc. of the IEEE Global Commun. Conf. (GLOBECOM), Dallas, Tex., USA, Nov. 29-Dec. 3, 2004, pp. 3999-4003.
[7] D. Hwan Lee, “OFDMA Uplink Ranging for IEEE 802.16e Using Modified Generalized Chirp-Like Polyphase Sequences,” in Proc. of Int. Conf. in Central Asia on Internet, Bishkek, Kyrgyz Republic, 26-29 Sept. 2005, pp. 1-5.
[8] Y. Zhou, Z. Zhang, and X. Zhou, “OFDMA Initial Ranging for IEEE 802.16e Based on Time-Domain and Frequency-Domain Approaches,” in Proc. of Int. Conf. on Commun. Techn. (ICCT), Guilin, China, 27-30 Nov. 2006, pp. 1-5.
[9] H. Mahmoud, H. Arslan, and M. Ozdemir, “Initial Ranging for WiMAX (802.16e) OFDMA”, in Proc. of the Military Commun. Conf., Washington D.C., 23-25 Oct. 2006, pp. 1-7.
[10] S. Sesia, I. Toufik, and M. P. J. Baker, LTE, The UMTS Long Term Evolution—From Theory to Practice, Wiley, 2009.
[11] X. Zhuang, K. Baum, V. Nangia, and M. Cudak, “Ranging Enhancement for 802.16e OFDMA PHY,” IEEE C802.16e-04/143, June 2004.
[12] X. Fu, Y. Li, and H. Minn, “A New Ranging Method for OFDMA Systems,” IEEE Trans. Wireless Commun., vol.

6, no. 2, pp. 659-669, February 2007.
[13] M. Morelli, L. Sanguinetti and H. V. Poor, “A Robust Ranging Scheme for OFDMA-Based Networks,” IEEE Trans. Commun., vol. 57, no. 8, pp. 2441-2452, August 2009.
[14] L. Sanguinetti, M. Morelli and H. V. Poor, “An ESPRIT-based approach for initial ranging in OFDMA systems,” IEEE Trans. Commun., vol. 57, no. 11, pp. 3225-3229, November 2009.
[15] L. Sanguinetti and M. Morelli, “An Initial Ranging Scheme for the IEEE 802.16 OFDMA Uplink,” to appear on IEEE Trans. Wireless Commun., accepted June 2012.
[16] D. Chu, “Polyphase codes with good periodic correlation properties,” IEEE Trans. Inf. Theory, vol. 18, no. 4, pp. 531-532, July 1972
[17] B. M. Popovic, “Efficient matched filter for the generalized chirp-like polyphase sequences,” IEEE Trans. Aer. Electr. Systems, vol. 30, no. 3, pp. 769-777, July 1994
[18] Panasonic, “R1-071517: RACH Sequence Allocation for Efficient Matched Filter Implementation', www.3gpp.org, 3GPP TSG RAN WG1, meeting 48bis, St Julians, Malta, March 2007.
[19] Huawei, “R1-071409: Efficient Matched Filters for Paired Root Zadoff-Chu Sequences,' www.3gpp.org, 3GPP TSG RAN WG1, meeting 48bis, St Julians, Malta, March 2007.
[20] W. W. Smith and J. M. Smith, Handbook of Real-time Fast Fourier Transforms. New York: Wiley Inter-Science, 1995.
[21] ITU-R, “Guidelines for evaluation of radio transmission technology for IMT-2000,” Recommendation ITU-R M. 1225, Tech. Rep., 1997.

1. A method for initial synchronisation between an eNodeB station (eNB) and a user equipment (UE) in a random access (RA) procedure in Long-Term Evolution (LTE) standards in wireless communication systems, comprising the steps of:
defining a Physical Random Access Channel (PRACH), said PRACH comprising a set of adjacent subcarriers;
notifying an entry request by a UE, said step of notifying comprising transmitting a random access RA code over said PRACH, said RA code randomly selected from a prefixed set of codes;
extracting said PRACH at said eNB, said step of extracting producing extracted samples;
processing said extracted samples, comprising the steps of:
detecting said random access code;
calculating a timing estimate;
calculating a power estimate,
for said initial synchronization
wherein
a step is provided of arranging said PRACH into tiles, each tile of said tiles comprising a predetermined subset (M) of adjacent subcarriers of said PRACH, and
said step of processing said extracted samples is carried out for each of said tiles.

2. A method according to claim 1, wherein, in said step of processing said extracted samples, a uniform channel response is assumed over each of said tiles, i.e. for each of said subcarriers of each of said tile, equal to an average frequency response.

3. A method according to claim 1, wherein said step of detecting said random access code comprises a binary hypothesis test wherein, for each code of said codes of said set of codes, a hypothesis of existence of said code is compared with a hypothesis of non-existence of said code.

4. A method according to claim 3, wherein said binary hypothesis test is a GLRT test.

5. A method according to claim 3, wherein said step of calculating a timing estimate is provided along with a step of calculating an estimate of the channel response in said hypothesis of existence of said code, and a step of calculating a noise estimate is provided for both said hypothesis of existence and of non existence of said codes.

6. A method according to claim 5, wherein said step of calculating a timing estimate and said step of calculating an estimate of the channel response timing error and the channel frequency response of the hypothesized codes are jointly carried out by using a maximum-likelihood (ML) criterion.

7. A method according to claim 5, wherein if said hypothesis of existence of a code of said codes is validated, said step of calculating a power estimate is carried out for the same code.

8. A method according to claim 5, wherein, if said hypothesis of non-existence of a code of said codes is validated, said step of processing said extracted samples continues by said binary hypothesis test for another of said codes.

9. A method according to claim 5, wherein said step of calculating a power estimate comprises the steps of
calculating a noise variance estimate;
combining said and said noise variance and said power estimate to provide an unbiased estimate of said power.

10. A method according to claim 3, wherein said step of processing said extracted samples comprises, for each of said tiles, a step of applying an inverse discrete Fourier transform (IDFT).

11. A method according to claim 1, wherein, in said step of calculating a timing estimate, the number of subcarriers (M) of each of said tiles is selected responsive to the number of subcarrier (M_{θ}) leading to a minimum value of the variance of timing estimate.

12. A method according to claim 11, wherein, in said step of calculating a timing estimate, the number of subcarriers (M_{P}) of each of said tiles is set between 3 and 10, in particular is set between 4 and 7.

13. A method according to claim 1, wherein, in said step of calculating a power estimate, the number of subcarriers (M_{θ}) of each of said tiles is selected responsive to the number of subcarrier leading to a minimum value of the variance of timing estimate.

14. A method according to claim 13, wherein, in said step of calculating a power estimate, the number of subcarriers (M_{P}) of each of said tiles is higher than 10, in particular is higher than 25.

15. A method according to claim 1, wherein the number of subcarriers (M) of each of said tiles is selected as an unique value both in said step of calculating a timing estimate and in said step of calculating a power estimate as a trade-off value.

16. A method according to claim 15, wherein the number of subcarriers (M) is set between 10 and 15, in particular is set between 11 and 14.

17. A method according to claim 1, wherein said step of processing said extracted samples is carried out at a plurality of receiving antennas of said eNB.

18. A method according to claim 3, wherein said steps of calculating a timing estimate and of calculating a noise estimate are carried out by a
detecting said random access code;
calculating a timing estimate, and
calculating a power estimate
of said step of processing said extracted samples are carried out jointly.

19. A method according to claim 1, wherein said step of processing said extracted samples comprises sequentially determining a parameter selected from the group comprised of said code; said timing estimate and said power estimate by a specific optimality criterion.
